(19) United States
(12) Patent Application Publication
(10) Pub. No.: US 2007/0195871 A1
(43) Pub. Date: Aug. 23, 2007

(54) Performance of DSL modem under impulse noise

(75) Inventors: Kapil Gulati, Sunnyvale, CA (US); Timothy Bornemisza, San Jose, CA (US); Madhu Hegde, Union City, CA (US); Raghuraman Mariappan, Sunnyvale, CA (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/703,382

(22) Filed: Feb. 6, 2007

Related U.S. Application Data
(60) Provisional application No. 60/775,555, filed on Feb. 22, 2006.

(51) Int. Cl. H04L 5/16

(52) U.S. Cl. 375/222

(57) ABSTRACT

Improving performance of DSL modem under impulse noise is disclosed. A method of improving a performance of a digital subscriber line (DSL) modem having an impulse noise of long duration includes assigning a value to each of framing parameters based on a rate adaptation algorithm which considers a signal to noise ratio (SNR) of a channel coupled to the DSL modem and a number of constraints applied to the DSL modem. The method also includes generating another set of values of the framing parameters maximizing an impulse noise protection (INP) of the DSL modem while meeting the number of constraints based on a limited set of possible values of the redundancy bytes per Reed Solomon codeword (Rₚ) of the framing parameters and a limited collection of possible values of the interleaver depth (Dₚ) of the framing parameters.

### FIELD OF TECHNOLOGY

This disclosure relates generally to the technical fields of telecommunication hardware and/or software, and in one embodiment, to a system and method of improving performance of a digital subscriber line (DSL) modem under impulse noise.

### BACKGROUND

Electronic equipment (e.g., a digital subscriber line (DSL) modem) may be exposed to a noisy environment. A thermal noise may arise due to a ceaseless random motion of electrons and/or atoms (e.g., especially within conductors). An electromagnetic interference (EMI) and/or a crosstalk may arise due to electrical and/or electronic activities surrounding the electronic equipment (e.g., such turning on and/or off the electrical equipment, fluctuations in power lines and/or electrical outlets, and/or a capacitive and/or inductive coupling).

An impulse noise may be non-stationary and/or occur in short bursts of various durations (e.g., with the bursts occurring either randomly and/or periodically). The effect of the impulse noise may distort signals and corrupt data (e.g., of the electronic equipment). The impulse noise may degrade a signal to noise ratio (SNR) of a channel and/or may cause significant errors in data transmission and/or reception. A video application may be especially sensitive to the impulse noise because it may cause a deterioration of video quality by wiping out video frames.

A DSL modem may be given a set of constraints under which the DSL modem is required to operate. A DSL loop having the DSL modem may be considered to have an excess capacity if the DSL modem meets the set of constraints and/or still have a room for further increasing a data rate of the DSL modem. The excess capacity may also be measured in terms of the DSL modem having an excess noise margin (e.g., a noise margin in excess of a predetermined target value).

When a DSL modem of a customer premise equipment (CPE) is turned on, the DSL modem may undergo a training phase (e.g., to establish a connection and to synchronize with a DSL modem of a central office (CO)). During the training phase, the DSL modem may execute a rate adaptation algorithm which considers the channel signal to noise ratio (SNR) and the set of constraints (e.g., established by the G.992.3 standard) to calculate a set of framing parameters.

ADSL/VDSL standards may specify framing schemes in which input user bytes are framed and coded prior to a DMT modulation. The ADSL/VDSL standards may allow two types of coding to provide improved data rates and robustness against the impulse noise. Reed Solomon (RS) coding may provide gains in presence of the impulse noise. In a deployment scenario, the set of constraints may be easily met and/or an achieved noise margin may be larger than a target noise margin. The difference (e.g., between the achieved noise margin and the target noise margin) may be referred to as the excess noise margin (e.g., which is also a measure of excess capacity).

The DSL modem (e.g., employing a traditional rate adaptation algorithm) may reduce a transmit power in order to reduce the excess noise margin, thus reducing the SNR (e.g., which in turn reduces the noise margin). Although the traditional rate adaptation algorithm may result in a power saving of the DSL modem, it may not be an appropriate way to utilize the excess noise margin and/or the excess capacity. Furthermore, a quality and/or integrity of data communicated through the DSL modem may be more important than the power saving when the impulse noise is prevalent and the excess noise margin and/or the excess capacity is available.

### SUMMARY OF THE DISCLOSURE

Improving performance of DSL modem under impulse noise is disclosed. In one aspect, a method of improving a performance of a digital subscriber line (DSL) modem (e.g., with an excess noise margin) having an impulse noise of long duration (e.g., which may rarely happen when compared to an interleaver delay (Delayₚ) of the DSL modem) includes assigning a value to each of framing parameters (e.g., which include Mux data frames per Reed Solomon codeword (Mₚ), a number of octets per Mux data frame (Kₚ), redundancy bytes per Reed Solomon codeword (Rₚ), an interleaver depth (Dₚ), a number of bits per discrete multi-tone modulation (DMT) symbol excluding trellis overhead (Lₚ), a first parameter controlling an overhead data rate (Tₚ), and a second parameter controlling the overhead data rate (MSG_{c})) based on a rate adaptation algorithm which considers a signal to noise ratio (SNR) of a channel coupled to the DSL modem and a number of constraints (e.g., a maximum net data rate, a minimum net data rate, a minimum impulse noise protection, a maximum interleaver delay, a minimum overhead data rate, a target bit error rate, and a target noise) applied to the DSL modem.

The method also includes generating another set of values of the framing parameters maximizing an impulse noise protection (INP) of the DSL modem while meeting the number of constraints based on a limited set of possible values of the redundancy bytes per Reed Solomon codeword (Rₚ) (e.g., which may be any one of 0, 2, 4, 6, 8, 10, 12, 14, and 16) of the framing parameters and a limited collection of possible values of the interleaver depth (Dₚ) (e.g., a finite number of constants) of the framing parameters.

The method may include concurrently increasing the number of bits per discrete multi-tone modulation (DMT) symbol excluding trellis overhead (Lₚ) and the redundancy bytes per Reed Solomon codeword (Rₚ) of the framing parameters such that an achieved data rate (NDRₚ) which falls between the maximum net data rate and the minimum net data rate optimizes the impulse noise protection (INP) while meeting the number of constraints. The method may also include heuristically applying possible values of the Mux data frames per Reed Solomon codeword (Mₚ), the number of octets per Mux data frame (Kₚ), the number of bits per discrete multi-tone modulation (DMT) symbol excluding trellis overhead (Lₚ), the first parameter controlling the overhead data rate (Tₚ), and the second parameter controlling the overhead data rate (MSG_{c}) per each combination of the limited set of possible values of redundancy bytes per Reed Solomon codeword (Rₚ) and the limited collection of possible values of the interleaver depth (Dₚ) during the generating another set of values of framing parameters.

In addition, the method may include generating an estimation of the excess noise margin based on the SNR, the number of constraints, and an initial best guess value of the framing parameters without performing the assigning the value to the each of framing parameters based on the rate adaptation algorithm. The method may further include automatically detecting the excess noise margin so as to perform the generating another set of values of framing parameters without reducing a transmission power of the DSL modem.

In another aspect, a method of improving a performance of a digital subscriber line (DSL) modem (e.g., with an excess noise margin) having a frequently occurring impulse noise of short duration (e.g., with a maximum delay of the DSL modem no greater than a period of the frequently occurring impulse noise of short duration, where the period is about few mili-seconds) includes assigning a value to each of framing parameters based on a rate adaptation algorithm which considers a signal to noise ratio (SNR) of a channel coupled to the DSL modem and a number of constraints applied to the DSL modem. The method also includes generating another set of values of the framing parameters minimizing an interleaver delay (Delayₚ) of the DSL modem while meeting the number of constraints based on a limited set of possible values of redundancy bytes per Reed Solomon codeword (Rₚ) of the framing parameters and a limited collection of possible values of an interleaver depth (Dₚ) of the framing parameters.

The method may include concurrently increasing number of bits per discrete multi-tone modulation (DMT) symbol excluding trellis overhead (Lₚ) and the redundancy bytes per Reed Solomon codeword (Rₚ) of the framing parameters while decreasing the interleaver depth (Dₚ) such that an achieved data rate which falls between a maximum net data rate and a minimum net data rate minimizes the interleaver delay (Delayₚ) while meeting the number of constraints. The method may further include heuristically applying possible values of Mux data frames per Reed Solomon codeword (Mₚ), a number of octets per Mux data frame (Kₚ), the number of bits per discrete multi-tone modulation (DMT) symbol excluding trellis overhead (Lₚ), a first parameter controlling an overhead data rate (Tₚ), and a second parameter controlling the overhead data rate (MSG_{c}) per each combination of the limited set of possible values of redundancy bytes per Reed Solomon codeword (Rₚ) and the limited collection of possible values of the interleaver depth (Dₚ) during the generating another set of values of framing parameters.

In addition, the method may include generating an estimation of the excess noise margin based on the SNR, the number of constraints, and an initial best guess value of the framing parameters without performing the assigning the value to the each of framing parameters based on the rate adaptation algorithm.

In yet another aspect, a system of a digital subscriber line (DSL) loop includes a first impulse noise maximization module of a first modem (e.g., having a first excess noise margin) of a central office on the DSL loop to generate a first set of values of framing parameters maximizing a first impulse noise protection (1^{st} INP) of the first modem associated with a first impulse noise of long duration while meeting a number of constraints based on any one of ADSL/VDSL standards. The system also includes a second impulse noise maximization module of a second modem (e.g., having a second excess noise margin) of a customer premise equipment communicatively coupled to the first modem to generate a second set of values of framing parameters maximizing a second impulse noise protection (2^{nd} INP) of the second modem associated with a second impulse noise of long duration while meeting the number of constraints based on the any one of ADSL/VDSL standards.

The system may include a first delay minimization module of the first modem to generate a third set of values of framing parameters minimizing a first interleaver delay (1^{st} Delayₚ) of the first modem while meeting the number of constraints associated with the any one of ADSL/VDSL standards. The system may also includes a second delay minimization module of the second modem to generate a fourth set of values of framing parameters minimizing a second interleaver delay (2^{nd} Delayₚ) of the second modem while meeting the number of constraints associated with the any one of ADSL/VDSL standards.

The system may further include an exhaustive search module to heuristically apply a limited set of possible values of the redundancy bytes per Reed Solomon codeword (Rₚ) and a limited collection of possible values of the interleaver depth (Dₚ) to generate at least one of the first set of values of framing parameters, the second set of values of framing parameters, the third set of values of framing parameters, and the fourth set of values of framing parameters. In addition, any one of the first modem and the second modem of the system may automatically reduce a transmit power of the any one of the first modem and the second modem based on a configuration data processed in the any one of the first modem and the second modem. Moreover, the system may include a rate adaptation module to assign a value to each of the framing parameters based on a rate adaptation algorithm which considers at least the number of constraints associated with the any one of ADSL/VDSL standards.

The methods, systems, and devices disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a customer premise equipment (CPE) communicating with a central office (CO) to connect to a global network, according to one embodiment.

FIG. 2 is a block diagram of the impulse noise optimization module of FIG. 1, according to one embodiment.

FIG. 3 is a process flow diagram of an algorithmic framework to maximize an impulse noise protection (INP) of a DSL modem under impulse noise, according to one embodiment.

FIG. 4 is a process flow diagram of an algorithmic framework to minimize an interleaver delay (Delayₚ) of a DSL modem under impulse noise, according to one embodiment.

Other features of the present embodiments will be apparent from the accompanying drawings and from the detailed description that follows.

### DETAILED DESCRIPTION

Techniques for improving performance of DSL modems under impulse noise scenarios are disclosed. In the following description, for the purposes of explanation, numerous specific details are set forth in order to provide a thorough understanding of the various embodiments. It will be evident, however to one skilled in the art, that the various embodiments may be practiced without these specific details.

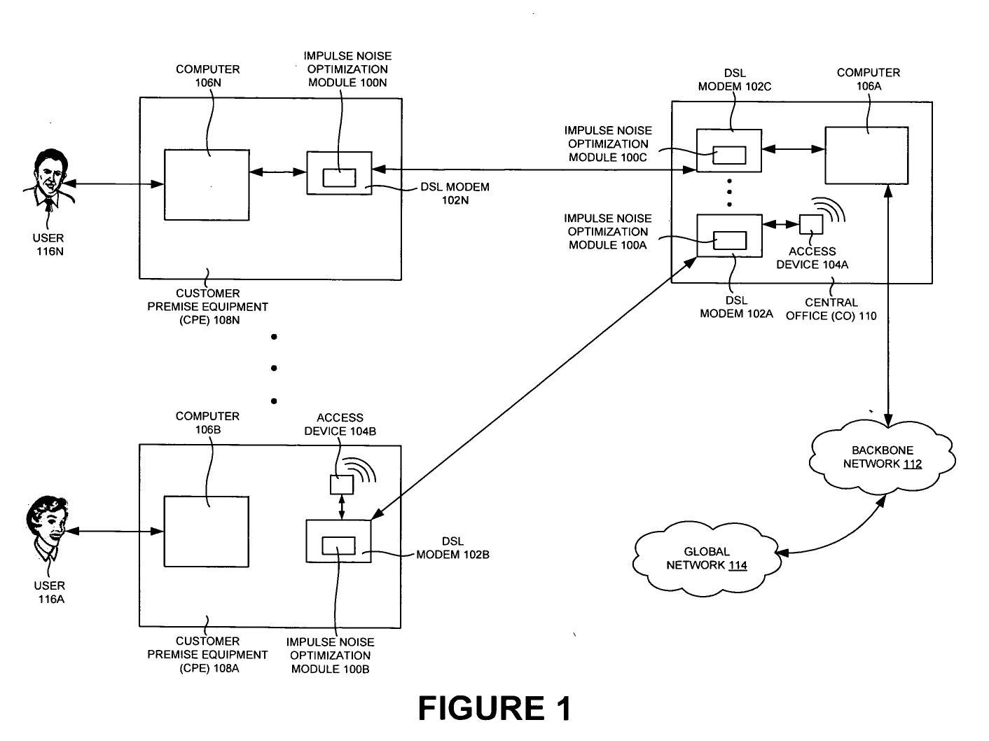

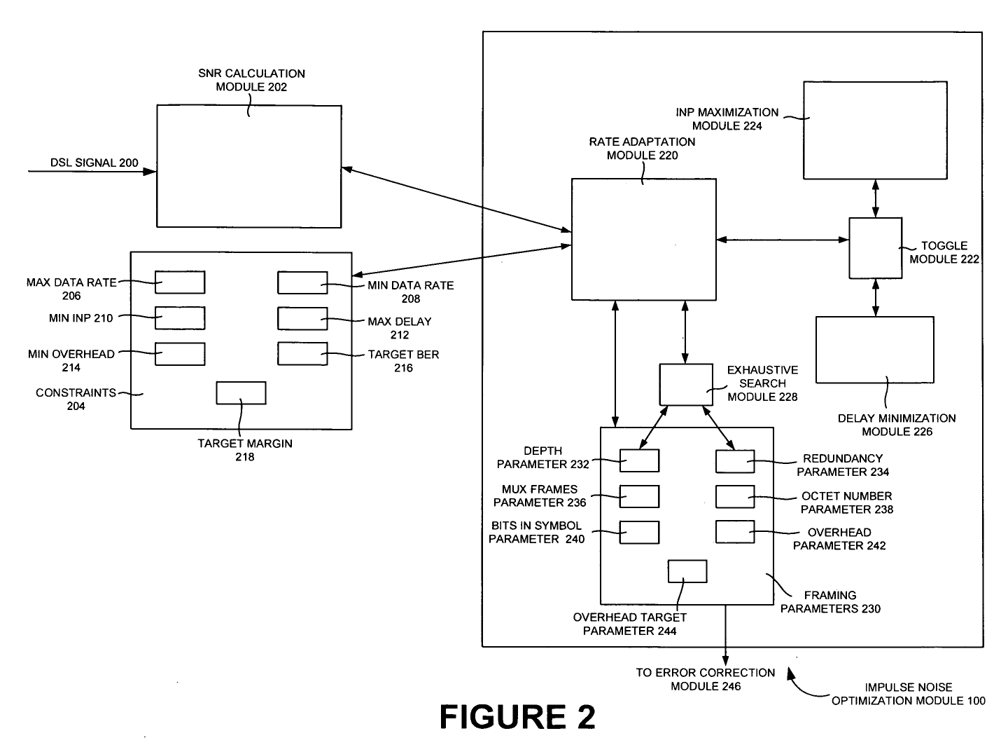

In one embodiment, a method of improving a performance of a digital subscriber line (DSL) modem (e.g., a DSL modem 102 of FIG. 1) having an impulse noise of long duration includes assigning a value to each of framing parameters based on a rate adaptation algorithm (e.g., a rate adaptation module 220 of FIG. 2) which considers a signal to noise ratio (SNR) of a channel coupled to the DSL modem and a number of constraints (e.g., constraints 204 of FIG. 2) applied to the DSL modem. The method also includes generating another set of values of the framing parameters (e.g., framing parameters 230 of FIG. 2) maximizing an impulse noise protection (INP) of the DSL modem while meeting the number of constraints based on a limited set of possible values of the redundancy bytes per Reed Solomon codeword (Rₚ) (e.g., a redundancy parameter 234) of the framing parameters and a limited collection of possible values of the interleaver depth (Dₚ) (e.g., a depth parameter 232) of the framing parameters.

In another embodiment, a method of improving a performance of a digital subscriber line (DSL) modem having a frequently occurring impulse noise of short duration includes assigning a value to each of framing parameters based on a rate adaptation algorithm which considers a signal to noise ratio (SNR) of a channel coupled to the DSL modem and a number of constraints applied to the DSL modem. The method also includes generating another set of values of the framing parameters minimizing an interleaver delay (Delayₚ) of the DSL modem while meeting the number of constraints based on a limited set of possible values of redundancy bytes per Reed Solomon codeword (Rₚ) of the framing parameters and a limited collection of possible values of an interleaver depth (Dₚ) of the framing parameters.

In yet another embodiment, a system of a digital subscriber line (DSL) loop includes a first impulse noise maximization module (e.g., an INP maximization module 224 of FIG. 2) of a first modem of a central office on the DSL loop to generate a first set of values of framing parameters maximizing a first impulse noise protection (1^{st} INP) of the first modem associated with a first impulse noise of long duration while meeting a number of constraints based on any one of ADSL/VDSL standards. The system also includes a second impulse noise maximization module of a second modem of a customer premise equipment communicatively coupled to the first modem to generate a second set of values of framing parameters maximizing a second impulse noise protection (2^{nd} INP) of the second modem associated with a second impulse noise of long duration while meeting the number of constraints based on the any one of ADSL/VDSL standards.

FIG. 1 is a system view of a customer premise equipment (CPE) 108 communicating with a central office (CO) 110 to connect to a global network 114, according to one embodiment. An impulse noise optimization module 100 may provide mechanisms to improve a robustness of a DSL modem 102 under impulse noise when a DSL loop having the DSL modem 102 has an excess capacity. The DSL modem 102 may be given a set of constraints under which it may be required to meet a target data rate. The DSL loop may have the excess capacity if the DSL modem 102 meets a set of constraints (e.g., which may be dictated by G.992.3) and/or still have a room for further increasing its data rate. The excess capacity may also be measured in terms of the DSL modem 102 having an excess noise margin (e.g., a noise margin in excess of a predetermined target value). The DSL modem 102 may be connected to a computer 106 via a cable (e.g., an Ethernet cable and/or a wireless access device 104). The DSL modem 102 may also be internal to the computer 106. The DSL modem 102 may allow the computer 106 to communicate through a plain old telephone service (POTS) distribution network (e.g., which may include twisted conductor pairs). The computer 106A may include and/or support multiple modems (e.g., the DSL modem 102A with an impulse noise optimization module 100A and/or the DSL modem 102C with an impulse noise optimization module 100C).

The DSL modem 102 may be typically installed in pairs (e.g., with the DSL modem 102B installed in the CPE 108A and the DSL modem 102A in the CO 110). The computer 106A of the CO 110 may be connected to a backbone network 112. The backbone network 112 may be of various types (e.g., the Ethernet). In one example embodiment, the computer 106A may communicate with a device and/or a system coupled to the backbone network 112. Moreover, the computer 106A may communicate, via the backbone network 112 with a global network 114 (e.g., the Internet). The system illustrated in FIG. 1 may allow a user 116 to connect the computer 106 of the CPE 108 to the global network 114 using the DSL modem 102 (e.g., which may be protected against impulse noise by the impulse noise optimization module 100).

FIG. 2 is a block diagram of the impulse noise optimization module 100 of FIG. 1, according to one embodiment. The impulse noise optimization module 100 may be broken up into internal conceptual components and/or external modules and/or databases. The DSL modem 102 may be required to meet certain constraints, embodied by constraints 204 (e.g., which are specified by the operator). The G.992.3 standard may specify constraints which include the following:
Maximum net data rate (max NDR 206)
Minimum net data rate (min NDR 208)
Minimum impulse noise protection (min INP 210)
Maximum interleaver delay (max Delay 212)
Minimum overhead data rate (min OH 214)
Target bit error rate (target BER 216)
Target noise margin (target NM 218)

These constraints 204 may be independently specified for the upstream and downstream directions. The upstream may refer to a data flow from the CPE 108 to the CO 110 and/or the downstream may refer to a data flow from the CO 110 to the CPE 108. Further, multiple data streams and/or multiple latency paths may be supported in each direction. Any given latency path may carry the multiple data streams. Any given data stream may map to only one latency path. The constraints listed above may be specified independently for each data stream. During a training phase of a modem (e.g., the DSL modem 102), a rate adaptation algorithm (e.g., which may be embodied as a rate adaptation module 220) may be executed. The rate adaptation module 220 may process a channel signal to noise ratio (SNR) from a SNR calculation module 202 and the constraints 204 to assign a set of values to framing parameters 230. The rate adaptation module 220 may also pick whether to use trellis coding and/or may also do a bit allocation based on the framing parameters and trellis setting. Typically the CPE 108 may be responsible for a downstream rate adaptation and/or the CO 110 may be responsible for an upstream rate adaptation.
The min NDR 208 and the max NDR 206 may specify an allowable range of a net user data rate.
The min INP 210 may specify a minimum required impulse noise protection in units of DMT symbols.
The max Delay 212 may place a limit on the end to end interleaver delay in ms (millisecond) that is incurred during data transmission. Voice applications may require this delay to be small whereas data and video applications may be able to tolerate higher delays.
The min OH 214 may specify a minimum required rate for an overhead channel. The overhead channel may be used for operations and maintenance.
The target BER 216 may specify a bit error rate performance of the data stream when the noise margin is 0 dB.
The target NM 218 may specify a headroom in dB that needs to be built in order to provide some protection against unanticipated noise increase once the DSL modem 102 is in showtime.

Typically the DSL modem 102 may achieve the target BER 216 of 1e-7 when the noise margin is 0 dB. The Target NM 218 may be set to 6 dB (e.g., which implies that the DSL modem 102 is able to tolerate an increase of 6 dB in the total noise power and/or still be able to maintain a BER of 1e-7 and/or better). The noise margin may provide a good protection against increases in crosstalk noise but may not be enough to provide a sufficient protection against impulse noises (e.g., which can have a very large amplitude).

G.992.3 specifies seven basic framing parameters:
Dₚ—Depth parameter 232 (e.g., interleaver depth).
Rₚ—Redundancy parameter 234 (e.g., redundancy bytes per RS codeword).
Mₚ—Mux frame parameter 236 (e.g., Mux data frames per RS codeword).
Kₚ—Octet number parameter 238 (e.g., number of octets per Mux data frame).
Lₚ—Bits in symbol parameter 240 (e.g., number of bits per DMT symbol excluding trellis overhead).
T—overhead parameter 242 (e.g., a parameter controlling an overhead data rate)
MSG_{c}—overhead target parameter 244 (e.g., another parameter controlling the overhead data rate).

P may refer to a latency path and/or may be 0, 1, 2, or 3 according to the G.992.3. The framing parameters 230 may determine the achieved net data rate, interleave delay and impulse noise protection according to the equations below:

NFECₚ=Mₚ*Kₚ+Rₚ (one RS codeword)

Sₚ=8*NFECₚ/Lₚ (number of DMT symbols per RS codeword)

INPₚ=4*Rₚ*Dₚ/Lₚ (achieved impulse noise protection)

Delayₚ=ceil(Sₚ*Dₚ)/4 (achieved interleaver delay)

NDRₚ=((Tₚ*Kₚ−1)*Mₚ*Lₚ*4)/(Tₚ*(Mₚ*Kₚ+Rₚ)) (achieved NDR in kbps)

OHₚ=Mₚ/(Tₚ*Sₚ)*MSG_{c}/SEQₚ (achieved overhead rate; SEQₚ depends on MSG_{c})

The rate adaptation module 220 may be successfully applied if the framing parameters 230 are such that we meet the following:
minNDR<=NDRₚ<=maxNDR
INPₚ>=minINP
Delayₚ<=maxDelay
OHₚ>=minOH
Achieved BER<=Target BER
Achieved NM>=Target NM (e.g., where ₚ may indicate an achieved value).

In one example embodiment, the DSL modem 102 may be able to correct a sequence of noise impulses as long as each impulse duration is less than or equal to INPₚ symbols and provided these impulses are spaced apart in time by Delayₚ (e.g., mili-seconds and/or more). When there is an excess capacity (e.g., the bits in symbol parameter 240 chosen by the rate adaptation module 220 is lower than what can potentially be sent over the channel), the DSL modem 102 may be allowed to reduce a transmit power in order to reduce the excess noise margin. Reducing transmit power reduces the channel SNR which in turn reduces the noise margin.

In another example embodiment, the DSL modem 102 may detect if there is an excess capacity. An algorithm (e.g., which may be embodied by the INP maximization module 224) may be executed to compute the framing parameters 230 to maximize a duration of impulse noise which may be tolerated without any errors during data reception (e.g., which in essence trades off the excess capacity for an improved INP). The algorithm may be adaptive to meet the MIN INP 210 (e.g., the minimum impulse noise protection), and/or may further obtain as high an INP duration as possible based on the excess capacity (e.g., through using the INP maximization module 224). The INP maximization module 224 may provide the best possible INP for a given channel condition. The INP maximization module 224 may be useful when the duration of impulse noise is somewhat unknown and large (e.g., few seconds, minutes, and/or hours) but the frequency of occurrence is small.

The delay minimization module 226 may be used when the duration of the noise event is small and deterministic but the frequency of occurrence is somewhat unknown and large. The delay minimization module 226 may meet the MIN INP 210 while minimizing the interleaver delay. The lower the interleave delay, the higher the frequency of impulse noise that can be tolerated without errors. The delay minimization module 226 may trade off the excess capacity for improved INP and/or provide a better protection against frequently occurring noise (e.g., every few mili-seconds, etc.). Both the INP maximization module 224 and the delay minimization module 226 may employ an exhaustive search to compute the framing parameters 230 through assigning finite sets of the depth parameter (Dₚ) 232 and the redundancy parameter (Rₚ) 234 (e.g., using the exhaustive search module 228). ADSL/VDSL standards may specify framing schemes in which the input user bytes are framed and coded prior to DMT modulation in an error correction module 246.

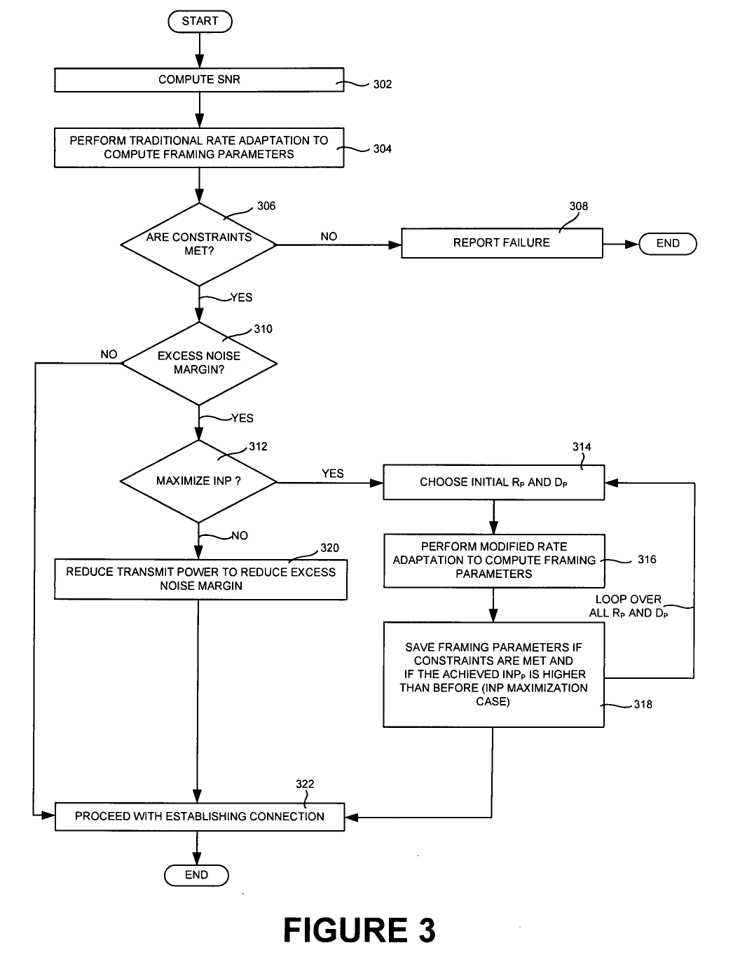

FIG. 3 is a process flow diagram of an algorithmic framework to maximize an impulse noise protection (INP) of the DSL modem 102 under impulse noise, according to one embodiment. Depending on the source of the noise, a DSL loop may be subject to impulses that vary from quite short to quite long in duration but happen only rarely, (e.g., once in few seconds or minutes or hours). For the DSL loop, a better strategy might be to:
provide the min INP 210 that is at least greater than the shortest impulse duration.
let the DSL modem 102 achieve the best possible INPₚ so as to provide robustness against fairly long impulses if there is the excess noise margin.

An operator of the DSL modem 102 may configure the DSL modem 102 to achieve the best possible INPₚ. On detecting this configuration, the DSL modem 102 may run a modified rate adaptation algorithm of operation 316 which meets all the constraints 204 whiling maximizing the INPₚ in operation 318. If there is an excess noise margin, the excess noise margin may be traded off for an increased INPₚ value. The achieved INPₚ may thus depend on the amount of excess noise margin available.

As illustrated in FIG. 3, in operation 302, a SNR of the channel may be computed. In operation 304, a traditional rate adaptation algorithm 304 may be performed. If constraints are met in operation 306, then the excess noise margin may be checked in operation 310, otherwise a failure may be reported as in operation 308. However if there is excess noise margin, and/or the INP maximization feature is turned on as in operation 312, then a modified rate adaptation algorithm may be performed in operation 316. Prior to operation 316, an initial value (e.g., out of all possible values) of the depth parameter 232 (Dₚ) and the redundancy parameter 234 (Rₚ) may be assigned. If the INP maximization feature is not on, then a transmit power of the DSL modem 102 may be reduced and/or proceed with establishing a connection as in operation 322.

As stated before:

INPₚ=4*Rₚ*Dₚ/4.

NDRₚ=((Tₚ*Kₚ−1)*Mₚ*Lₚ*4)/(Tₚ*(Mₚ*Kₚ+Rₚ))

Note that the INPₚ may be directly proportional to the redundancy parameter (Rₚ) 234 and the depth parameter (Dₚ) 232 and inversely proportional to the bits in symbol parameter (Lₚ) 240. Hence at a given Lₚ 240, increasing Rₚ*Dₚ product may lead to an increased INPₚ. However, blindly maximizing the Rₚ 234 and Dₚ 232 may end up violating other constraints like the min NDR 208, the max Delay 212, etc. For example, increasing Rₚ 234 may decrease the NDRₚ. However, if there is excess noise margin available the bits in symbol parameter 240 (Lₚ) may be increased together with the redundancy parameter 234 (Rₚ) such that the NDRₚ still meets the constraints. By increasing both the Lₚ 240 and the Rₚ 234, the excess noise margin may be traded off with an increased INPₚ.

Allowed values of the Rₚ 234 and the Dₚ 232 may be finite. For example all ADSL/VDSL2 standards may allow the Rₚ 234 to take values only from a small set of (e.g., 0, 2, 4, 6, 8, 10, 12, 14, and 16). Similarly the Dₚ 232 may only take values from a finite set. In one example embodiment, a modified rate adaptation algorithm may iterate over all possible values of the Rₚ 234 and the Dₚ 232. For any given value of the Rₚ 234 and/or the Dₚ 232, the modified rate adaptation algorithm may be executed in operation 318 that computes the remaining framing parameters in order to meet all the constraints. The modified rate adaptation may compute the remaining parameters heuristically and/or by any other means. The modified rate adaptation algorithm may allow to cover the complete range of the Rₚ 234 and the Dₚ 232 which are the two key parameters governing the INPₚ. By controlling the two parameters, an INPₚ value higher than the min INP 210 may be obtained. The resulting framing parameters may have a higher value for each of the Rₚ 234, the Dₚ 232 and the Lₚ 240, thus leading to higher INPₚ but lower excess noise margin.

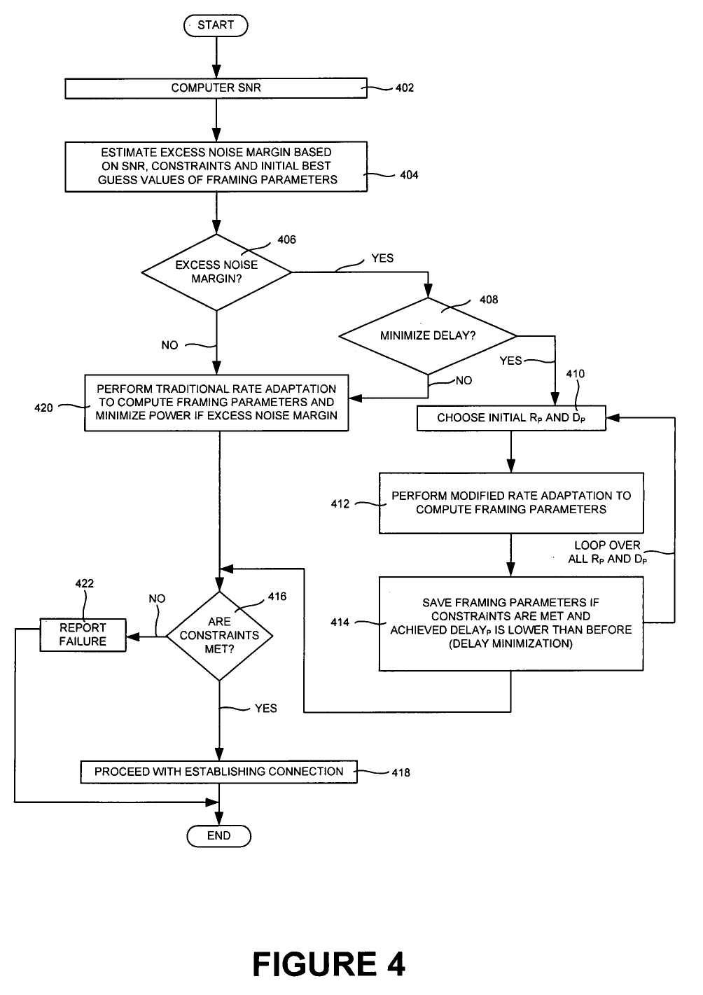

FIG. 4 is a process flow diagram of an algorithmic framework to minimize an interleaver delay (Delayₚ) of the DSL modem 102 of FIG. 1 under impulse noise, according to one embodiment. In operation 404, the excess margin may be estimated early on to figure out which path to take. Depending on the source of the noise, a DSL loop may be subject to impulses that are of small duration but happen very frequently (e.g., every 10 mili-seconds where the period is tied to the 50 Hz AC supply frequency). For the DSL loop, a better strategy may be to:
provide the min INP 210 that is at greater than the impulse duration.
provide the max Delay 212 that is at most equal to impulse time period (e.g., 10 ms).
let the DSL modem 102 achieve the lowest possible Delayₚ so as to provide robustness against even smaller impulse time periods if there is an excess noise margin.

Lower delay may be preferable for all applications (e.g., with and/or without an impulse noise). In operation 402, the SNR may be computed, and then the excess noise margin may estimated based on the SNR, the constraints and initial best guess values of the framing parameters 230 in operation 404. In operation 406, the excess noise margin may be checked. If there is the excess noise margin, then an operator may turn the interleave delay minimization feature ON by appropriately configuring the modem as in operation 408. The DSL modem 102 may run a modified rate adaptation algorithm in operation 412 which meets all the constraints while minimizing the Delayₚ in operation 414. If there is the excess noise margin, the excess noise margin may be traded off for a decreased Delayₚ value.

As stated before:

INPₚ=4*Rₚ*Dₚ/Lₚ

NDRₚ=((Tₚ*Kₚ−1)*Mₚ*Lₚ*4)/(Tₚ*(Mₚ*Kₚ+Rₚ))

Delayₚ=ceil(Sₚ*Dₚ)/4 =ceil(8*(Mₚ*Kₚ+Rₚ)*Dₚ/Lₚ)/4

Note that the Delayₚ is directly proportional to the depth parameter (Dₚ) 232 and inversely proportional to the Lₚ 240. The Delayₚ may also be proportional to the Rₚ 234 although the dependency may not be as strong as for the INPₚ. Hence decreasing the Dₚ 232 and the Rₚ 234 may in general lead to a smaller delay with decrease in the Dₚ 232. However, blindly decreasing the Rₚ 234 and the Dₚ 232 may end up violating other constraints like the min INP 210. If there is an excess noise margin available, the Dₚ 232 may be decreased to reduce a delay, and increase the Lₚ 240 together with the Rₚ 234 such that the INPₚ and the NDRₚ still meet the constraints 204. This effectively trades off excess noise margin for a smaller delay. An optimum point which gives the minimum Delayₚ may be obtained while still meeting the constraints 204.

Allowed values of the Rₚ 234 and the Dₚ 232 are finite. For example all ADSL/VDSL2 standards allow the Rₚ 234 to take values only from a small set of (e.g., 0, 2, 4, 6, 8, 10, 12, 14, and 16). Similarly the Dₚ 232 may only take values from a finite set. The modified rate adaptation algorithm of operation may iterate over all possible values of the Rₚ 234 and the Dₚ 232. For any given Rₚ 234 and Dₚ 232 combination, the modified rate adaptation algorithm may be executed that computes the remaining framing parameters in order to meet all the constraints in operation 414. The modified rate adaptation may compute the remaining parameters heuristically and/or by any other means, thus covering the complete range of the Rₚ 234 and the Dₚ 232 which are the two key parameters governing Delayₚ. By controlling these two parameters precisely, the framing parameters 230 may be obtained which provides a lower Delayₚ and/or a lower excess noise margin. Once the exhaustive search (e.g., using the exhaustive search module 228 of FIG. 2) is completed the framing parameters 230 may be checked to see if they meet the constraints. If the constraints are met, then the DSL modem 102 may establish a connection in operation 418. Otherwise, a failure may be reported in operation 422. In the event that there is no excess noise margin and/or the delay minimization module 226 is turned off, the DSL modem 102 may undergo a traditional rate adaptation to compute the framing parameters and then minimize power if as a result there is an excess noise margin in operation 420. The DSL modem 102 may check the constraint 204 in operation 416.

In another example embodiment, the technique of delay minimization and/or impulse noise protection maximization may be used with an erasure decoding with just a slight change of the formulae. Erasure decoding may change the formula of INPₚ from 4*Rₚ*Dₚ/Lₚ to 8*tₚ*Dₚ/Lₚ where tₚ depends on Rₚ 234 and the gain provided by erasure. Theoretically tₚ can be as high as Rₚ 234 although in practice it may be somewhere between Rₚ/2 and Rₚ. Similarly for VDSL2 30 MHz profile, which has double the symbol rate, the Delayₚ formula may change to ceil(Sₚ*Dₚ)/8.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

For example the impulse noise optimization module 100 of FIG. 1, and/or the SNR calculation module 202, the rate adaptation module 220, the toggle module 222, the INP maximization module 224, the delay minimization module 226, and the exhaustive search module 228 of FIGS. 2 may be embodied through an impulse noise optimization circuit, a SNR calculation module 202, a rate adaptation circuit, a toggle circuit, an INP maximization circuit, a delay minimization circuit, and an exhaustive search circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of improving a performance of a digital subscriber line (DSL) modem having an impulse noise of long duration, comprising:
assigning a value to each of framing parameters based on a rate adaptation algorithm which considers a signal to noise ratio (SNR) of a channel coupled to the DSL modem and a number of constraints applied to the DSL modem; and
generating another set of values of the framing parameters maximizing an impulse noise protection (INP) of the DSL modem while meeting the number of constraints based on a limited set of possible values of redundancy bytes per Reed Solomon codeword (Rₚ) of the framing parameters and a limited collection of possible values of an interleaver depth (Dₚ) of the framing parameters, wherein the DSL modem to have an excess noise margin.

2. The method of claim 1, wherein the framing parameters to include Mux data frames per Reed Solomon codeword (Mₚ), a number of octets per Mux data frame (Kₚ), the redundancy bytes per Reed Solomon codeword (Rₚ), the interleaver depth (Dₚ), a number of bits per discrete multi-tone modulation (DMT) symbol excluding trellis overhead (Lₚ), a first parameter controlling an overhead data rate (Tₚ), and a second parameter controlling the overhead data rate (MSG_{c}).

3. The method of claim 2, wherein the number of constraints to include a maximum net data rate, a minimum net data rate, a minimum impulse noise protection, a maximum interleaver delay, a minimum overhead data rate, a target bit error rate, and a target noise margin.

4. The method of claim 3, wherein the limited set of possible values of the redundancy bytes (Rₚ) based on an ADSL/VDSL2 standard to include 0, 2, 4, 6, 8, 10, 12, 14, and 16, and the limited collection of possible values of the interleaver depth (Dₚ) to include a finite number of constants.

5. The method of claim 4, further comprising concurrently increasing the number of bits per discrete multi-tone modulation (DMT) symbol excluding trellis overhead (Lₚ) and the redundancy bytes per Reed Solomon codeword (Rₚ) of the framing parameters such that an achieved data rate (NDRₚ) which falls between the maximum net data rate and the minimum net data rate optimizes the impulse noise protection (INP) while meeting the number of constraints.

6. The method of claim 5, further comprising heuristically applying possible values of the Mux data frames per Reed Solomon codeword (Mₚ), the number of octets per Mux data frame (Kₚ), the number of bits per discrete multi-tone modulation (DMT) symbol excluding trellis overhead (Lₚ), the first parameter controlling the overhead data rate (Tₚ), and the second parameter controlling the overhead data rate (MSG_{c}) per each combination of the limited set of possible values of redundancy bytes per Reed Solomon codeword (Rₚ) and the limited collection of possible values of the interleaver depth (Dₚ) during the generating another set of values of the framing parameters.

7. The method of claim 6, further comprising generating an estimation of the excess noise margin based on the SNR, the number of constraints, and an initial best guess value of the framing parameters without performing the assigning the value to the each of framing parameters based on the rate adaptation algorithm.

8. The method of claim 1, further comprising automatically detecting the excess noise margin so as to perform the generating another set of values of the framing parameters without reducing a transmission power of the DSL modem.

9. The method of claim 1, wherein the impulse noise of long duration to rarely happen when compared to an interleaver delay (Delayₚ) of the DSL modem.

10. The method of claim 1 in a form of a machine-readable medium embodying a set of instructions that, when executed by a machine, causes the machine to perform the method of claim 1.

11. A method of improving a performance of a digital subscriber line (DSL) modem having a frequently occurring impulse noise of short duration, comprising:
assigning a value to each of framing parameters based on a rate adaptation algorithm which considers a signal to noise ratio (SNR) of a channel coupled to the DSL modem and a number of constraints applied to the DSL modem; and
generating another set of values of the framing parameters minimizing an interleaver delay (Delayₚ) of the DSL modem while meeting the number of constraints based on a limited set of possible values of redundancy bytes per Reed Solomon codeword (Rₚ) of the framing parameters and a limited collection of possible values of an interleaver depth (Dₚ) of the framing parameters, wherein the DSL modem to have an excess noise margin.

12. The method of claim 11, further comprising concurrently increasing number of bits per discrete multi-tone modulation (DMT) symbol excluding trellis overhead (Lₚ) and the redundancy bytes per Reed Solomon codeword (Rₚ) of the framing parameters while decreasing the interleaver depth (Dₚ) such that an achieved data rate which falls between a maximum net data rate and a minimum net data rate minimizes the interleaver delay (Delayₚ) while meeting the number of constraints.

13. The method of claim 12, further comprising heuristically applying possible values of Mux data frames per Reed Solomon codeword (Mₚ), a number of octets per Mux data frame (Kₚ), the number of bits per discrete multi-tone modulation (DMT) symbol excluding trellis overhead (Lₚ), a first parameter controlling an overhead data rate (Tₚ), and a second parameter controlling the overhead data rate (MSG_{c}) per each combination of the limited set of possible values of redundancy bytes per Reed Solomon codeword (Rₚ) and the limited collection of possible values of the interleaver depth (Dₚ) during the generating another set of values of the framing parameters.

14. The method of claim 13, further comprising generating an estimation of the excess noise margin based on the SNR, the number of constraints, and an initial best guess value of the framing parameters without performing the assigning the value to the each of framing parameters based on the rate adaptation algorithm.

15. The method of claim 11, wherein a maximum delay of the DSL modem is no greater than a period of the frequently occurring impulse noise of short duration, wherein the period is about few mili-seconds.

16. A system of a digital subscriber line (DSL) loop, comprising:
a first impulse noise maximization module of a first modem of a central office on the DSL loop to generate a first set of values of framing parameters maximizing a first impulse noise protection (1^{st} INP) of the first modem associated with a first impulse noise of long duration while meeting a number of constraints based on any one of ADSL/VDSL standards, wherein the first modem to have a first excess noise margin; and
a second impulse noise maximization module of a second modem of a customer premise equipment communicatively coupled to the first modem to generate a second set of values of framing parameters maximizing a second impulse noise protection (2^{nd} INP) of the second modem associated with a second impulse noise of long duration while meeting the number of constraints based on the any one of ADSL/VDSL standards, wherein the second modem to have a second excess noise margin.

17. The system of claim 16 further comprising:
a first delay minimization module of the first modem to generate a third set of values of framing parameters minimizing a first interleaver delay (1^{st} Delayₚ) of the first modem while meeting the number of constraints associated with the any one of ADSL/VDSL standards; and
a second delay minimization module of the second modem to generate a fourth set of values of framing parameters minimizing a second interleaver delay (2^{nd} Delayₚ) of the second modem while meeting the number of constraints associated with the any one of ADSL/VDSL standards.

18. The system of claim 17 further comprising an exhaustive search module to heuristically apply a limited set of possible values of the redundancy bytes per Reed Solomon codeword (Rₚ) and a limited collection of possible values of the interleaver depth (Dₚ) to generate at least one of the first set of values of framing parameters, the second set of values of framing parameters, the third set of values of framing parameters, and the fourth set of values of framing parameters.

19. The system of claim 18, wherein any one of the first modem and the second modem to automatically reduce a transmit power of the any one of the first modem and the second modem based on a configuration data processed in the any one of the first modem and the second modem.

20. The system of claim 19, further comprising a rate adaptation module to assign a value to each of the framing parameters based on a rate adaptation algorithm which considers at least the number of constraints associated with the any one of ADSL/VDSL standards.
